(19) United States
(12) Patent Application Publication
(10) Pub. No.: US 2003/0009245 A1
(43) Pub. Date: Jan. 9, 2003

(54) Evolution strategy computing system, method and program for operating individuals consisting of real value

(75) Inventors: Kanji Ueda, Yao City (JP); Kazuhiro Ohkura, Kobe City (JP)

Correspondence Address: OLIFF & BERRIDGE, PLC, P.O. BOX 19928, ALEXANDRIA, VA, 22320, US

(73) Assignee: KOBE UNIVERSITY, Kobe City (JP)

(21) Appl. No.: 10/101,226

(22) Filed: Mar. 20, 2002

(30) Foreign Application Priority Data
Mar. 22, 2001 (JP) 2001-83,459

(51) Int. Cl. G06F 155/00

(52) U.S. Cl. 700/91

(57) ABSTRACT

The invention provides an evolution strategy computing system, method and program having an enhanced self-adaptiveness in evolutionary process by introducing an effect of genetic drift to improve a searching robustness using inactive strategy parameters.

### BACKGROUND OF THE INVENTION

1. Field of the Invention

The present invention relates to an Evolutionary Computation (EC) which could be widely applied to real function optimization problems arising in various aspects of engineering design fields, and more particularly, relates to an Evolution Strategies (ES) computing system and an ES computing method. The present invention also relates to an ES computing program.

2. Background Art

Evolutionary computation technique has been recognized as a robust approach to various kinds of engineering optimization problems. There are three main streams in this field, Genetic Algorithm (GA), Evolutionary Programming (EP) and Evolution Strategies (ES). Among these streams, researches of ES have been specializing in numerical optimization owing to its inception, thus ES has been considered to be superior to the other techniques in this field. Characteristic of algorithm of ES is as follows:

(1) To handle individuals consisting of directly arranged real numbers, instead of genetic type coded individuals such as binary numeral.

(2) To use mainly mutations on one individual rather than recombination of two individuals as replace operators.

(3) To use a determinative selecting step.

It should be noted that in ES, the mutations are operations in which respective values on an individual are changed by adding them perturbation whose size is defined in probability.

In ES technique, strategy parameters are utilized as parameters for controlling a step size of mutations. These strategy parameters are most important things in ES technique, thus searching behavior is substantially decided by the parameters. In addition, it has been thought that the strategy parameters are sufficiently and appropriately controlled in ES under the favor of its nature of self-adaptive. However, if problems to be solved are difficult such that problems are raised to higher dimension or landscape becomes too complicated to effect optimization, the strategy parameters are liable to be converged toward zero (i.e. the parameters get smaller) before finding the global optimum, so that s step size of mutations becomes extremely lower and individuals cannot easily move to any other point. In this manner, a so-called “premature convergence” is liable to occur. To avoid the premature convergence, a lower bound is generally set to prevent the strategy parameters to be smaller than the lower limit.

When EC is applied to optimization problems, if a population of individuals runs into the convergence at early stages, a global optimum solution could not be found. Meanwhile, if the population runs into convergence at late stages, a lot of computing power is consumed. Therefore, balance of reproduction (breeding) and natural selection must be suitably adjusted to control multiplicity. In the present specification, the reproduction means a process of generating individuals as offsprings from a population of individuals as its parents, and the natural selection means a process of selecting some of individuals as a next generation population from a generated population of individuals as offsprings. Also, the multiplicity means a aspect that various individuals exist in a population. The selection process is definitely performed in ES technique, and therefore the reproduction process will be discussed below. In ES, since a mutation is a primary replace operator, the step size of mutations which has been considered to be self-adaptive could be enhanced in any manner in ES.

An article, “Are Evolutionary Algorithms Improved by Large Mutations ?” (C. Kappler, pp. 346-355, Proc. Parallel Problem Solving from Nature IV, Vol. 1141 of Lecture Notes in Computer Science, Spring-Verlag, H.-M. Voigt eds.) discloses a mutation technique in which performance of (1+1)−ES is improved by using Cauchy distribution instead of Gaussian distribution. A document, “Fast evolution strategies” (X. Yao and Y. Lieu, pp. 467-496, Control and Cybernetics, 26(3)) discloses a mutation technique based on Cauthy distribution in reproduction process. They studied this technique in computer simulation using many test functions and found that the technique is applicable to many problems, especially to multimodal function optimization problems. They called their technique Fast-ES (FES) in order to distinguish it from classical ES (CES, which is using Gaussian distribution).

It is known that performance of ES depends on a value of the above described lower limit of strategy parameters and a preferable lower limit value is changeable in accordance with particular problem characteristics. Therefore, the lower bound must be determined on ahead in consideration of each of problem characteristics. However, this approach has following demerits:

(1) Local searching ability degrades since the step size could not be lowered than the lower bound;

(2) Setting the lower bound in accordance with problem characteristics is not preferable in a view point of robustness at which EC aims inherently.

Thus, a setting a lower bound on ahead is not an appropriate solution.

C. Kappler reports that, if the mutation step size is calculated using Cauthy distribution, performance of (1+1)−ES (one individual yields one child) is measured and its value is useful for low dimension searching problem but is not useful for higher dimension searching problem. Furthermore, in the FES of Yao, brittleness of lower bound of strategy parameters is not addressed, and thus it is necessary to set a lower bound according to problem characteristic.

### SUMMARY OF THE INVENTION

In view of circumstances described above, we considered that the fault of ES in respect of robustness occur because self adaptive is insufficient in evolutionary process, therefore, the present invention has for its object to improve robustness of searching by increasing self-adaptive. In other words, the object of the present invention is to provide an evolution strategy computing system having an enhanced self-adaptiveness in evolutionary process by introducing an effect of genetic drift to improve a searching robustness. Another object of the present invention is to provide an evolution strategy computing method and an equivalent storage media have an enhanced self-adaptiveness in evolutionary process by introducing an effect of genetic drift to improve a searching robustness.

According to the invention, an evolution strategy computing system handling individuals consisting of real values comprises:

storage means for storing a matrix of strategy parameters comprising active strategy parameters and a plurality of inactive strategy parameters and at least one replace operator having a predetermined probability;

operating means for leading the replace operator from said storage means to operate the matrix of the strategy parameters of respective individuals based on the probabilities of the readout replace operators;

strategy parameter mutation means for mutating said operated strategy parameters in the matrix; and

individual mutation means for mutating said individuals consisting of real values based on said operated and mutated strategy parameters in the matrix.

In a preferable embodiment of the evolution strategy computing system according to the invention, said strategy parameter mutation means and/or said individual mutation means mutates in Cauthy type.

In another preferable embodiment of the evolution strategy computing system according to the invention, said matrix of the strategy parameters consists of active strategy parameters (j, 1) and inactive strategy parameters η(j, 2)−η(j, m), and said operating means comprises first shifting means for shifting all of said strategy parameters except a leftmost parameter to one's immediate right position one by one in the matrix and for removing the leftmost parameter.

In another preferable embodiment of the evolution strategy computing system according to the invention, said matrix of the strategy parameters consists of active strategy parameters η(j, 1) and inactive strategy parameters η(j, 2)−η(j, m), and said operating means comprises second shifting means for shifting all of said inactive parameters to one's immediate left position one by one in the matrix to replace the active strategy parameter by the inactive strategy parameter in one's immediate right position.

In still another embodiment of the evolution strategy computing system according to the invention, said matrix of the strategy parameters consists of active strategy parameters η(j, 1) and inactive strategy parameters η(j, 2)−η(j, m), and said operating means comprises swap means for swapping said active strategy parameter for one of said inactive parameters which is randomly selected.

### BRIEF DESCRIPTION OF THE DRAWINGS

FIG. 1 is a block diagram illustrating the basic arrangement of a computer system for performing the evolution strategy computing systems according to the invention;

FIG. 2 is a block diagram showing each of functions of the evolution strategy computing systems according the invention;

FIG. 3 is a flow diagram showing an algorithm of conventional method of FES;

FIG. 4 is a flowchart illustrating an algorithm of the method of RES (Robust Evolution Strategies) according to present invention;

FIGS. 5a, 5b and 5c are graphs illustrating results of simulation with respect to the hypersphere function f₁ in CES, FES and RES according to the invention, respectively, with six different lower bound conditions; and

FIGS. 6a, 6b and 6c are graphs depicting results of mutation with respect to the Ackley function f₂ in CES, FES and RES according to the invention, respectively, with six different lower bound conditions.

### DETAILED DESCRIPTION OF THE PREFERRED EMBODIMENTS

The evolution strategy computing systems according to the invention will be described with reference to several embodiments shown in the accompanying drawings. For convenience of explanation, present invention will be described as the systems (i.e. devices), however it should be understood that the invention could be implemented as corresponding methods and programs (or computer readable storage media).

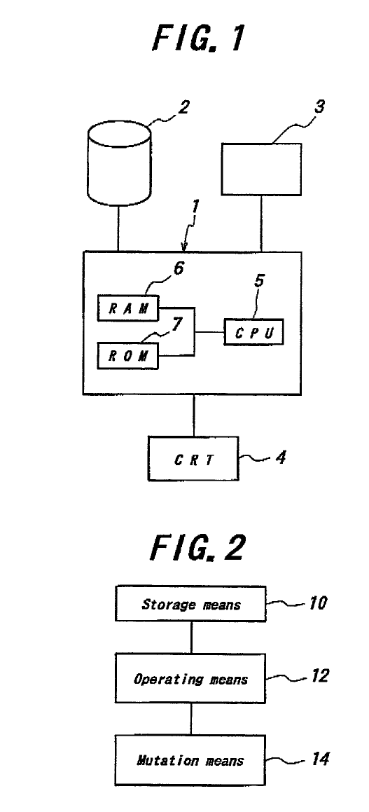

FIG. 1 is a block diagram illustrating the basic arrangement of a computer system in which the evolution strategy computing systems according to the invention is carried out. As illustrated in the FIG. 1, a computer system 1 comprises an auxiliary storage 2, an I/O device 3, a display device 4, a CPU 5, a RAM 6 and a ROM 7. A program implementing the evolution strategy computing systems according the invention is stored in the auxiliary storage 2 or ROM 7. Prior to the operation, the program is loaded into the RAM 6 based on instruction by I/O device 3 such as a keyboard or a mouse, then the program are executed in the CPU 5. The display device, such as a CRT or a LCD, can be used to display result of the processed data by the system such as graphical form.

FIG. 2 is a block diagram showing respective functions of the evolution strategy computing system according the invention. As shown in FIG. 2, the evolution strategy computing system comprises mainly storage means 10, operating means 12 and mutation means 14.

The basic principle of the invention is that the strategy parameters could be operated by stochastic factor of transformation rather than selection pressure, so that the strategy parameters hardly accrete certain value. To this end, in addition to the conventional effective parameter (which is referred to as an active strategy parameter herein for the sake of convenience) utilized in the conventional ES or FES, newly strategy parameters (which are referred to as inactive strategy parameters) are introduced. These inactive strategy parameters are redundant (i.e. inactive) and do not affect immediately on evolutionary process. Furthermore, according to the present invention, there is introduced a novel mutation method, in which a current parameter value is changed in regardless of inactive or active strategy parameter and an active strategy parameter is replaced by one of any redundant (inactive) strategy parameters. In this novel mutation mechanism an active parameter replaced by inactive ones, and a genetic drift is introduced for changing active parameters substantially acting on the evolutionary. In this connection, the genetic drift means that a neutral data region irrelevant to the selection pressure is additionally provided data (inactive strategy parameters) stored in this region is changed in stochastic, and an active strategy parameter is replaced by one of them with a small probability such that the active strategy parameter is determined not only by the source of natural selection pressure bat also by the above described mechanism.

Now, in order to distinguish the evolution strategy computing method of the invention from prior art techniques, a standard computing method in the conventional ES will be described. ES was developed to solve technical optimization problems of constructing an optimal flashing nozzle at Technical University of Berlin (TUB) in Germany in 1964. In the following year, I. Rechenberg et al. proposed the (1+1)−ES in which one parent generates one offspring per generation. Then, ES was refined into the (μ+1)−ES in which μ parents (μ>1) generate one offspring and replace most inferior parent by the generated offspring. After that, Hans-Paul Schwefel et al. proposed the (μ, λ)−ES. Now, (μ, λ)−ES is the most standard form.

The (μ, λ)−ES is formulated as follows. First, in n-dimension of real functions optimization problem, individuals Xi (i=1,2, . . . ,μ) in parent population is defined using n dimension real valued vector χ_{I} and n dimension strategy parameter ηᵢ as follows:

Xᵢ={χᵢηᵢ } (1)

χᵢ={χᵢ(1),χᵢ(2), . . . ,χᵢ(j)}(χᵢ(j)εR) (2)

ηᵢ={ηᵢ(1),ηᵢ(2), . . . ,ηᵢ(j)}(ηᵢ(j)εR⁺) (3)

where i=1,2, . . . ,μ, j=1,2, . . . ,n, χᵢ(j),ηᵢ(j) denote the j-th component values of the vectors of χᵢ and ηᵢ, respectively.

Next, λ offsprings:

$${\tilde{X}}_{i}^{k} ( i = 1 , 2 , … , μ ; k = {k}_{1} , {k}_{2} , … , {k}_{μ} ; {\sum }_{i = 1}^{μ} {k}_{i} = λ )$$

generated from μ parents: Xi(i=1,2, . . . ,m) is defined as follows:

\tilde{X}ᵢ^{k}={\tilde{χ}ᵢ^{k},\tilde{η}ᵢ^{k}} (4)

\tilde{χ}ᵢ^{k}={χᵢ^{k}(1),χᵢ^{k}(2), . . . ,χᵢ^{k}(j)}(\tilde{χ}ᵢ^{k}(j)εR) (5)

\tilde{η}ᵢ^{k}={\tilde{η}ᵢ^{k}(1),\tilde{η}ᵢ^{k}(2), . . . ,\tilde{η}ᵢ^{k}(j)}(\tilde{η}ᵢ^{k}(j)εR⁺) (6)

where \tilde{χ}ᵢ^{k},\tilde{η}ᵢ^{k} denote element values of k-th individual of kᵢ offsprings generated from i-th parents, respectively,

\tilde{χ}ᵢ^{k}(j),\tilde{η}ᵢ^{k}(j) denote j-th component values of each of vectors, respectively.

k-th offspring is generated from parents according to following equations.

\tilde{η}ᵢ^{k}(j)=ηᵢ(j)exp(τ′N(0,1)+τNᵢⱼ^{k}(0,1)) (7)

\tilde{χ}ᵢ^{k}(j)=χᵢ(j)+\tilde{η}ᵢ^{k}(j)Nᵢⱼ^{k}(0,1) (8)

where N(0,1) denotes one-dimensional random numbers obtained from a standard normal distribution with a mean value of zero and a standard deviation of unit;

Nᵢⱼ^{k}(0,1) denotes random numbers ruled by standard normal distributions attained independently for i,j and k. The factor of τ and τ′ is commonly defined as follows:

$$τ = {( \sqrt{2 \sqrt{n}} )}^{- 1} \qquad ( 9 )$$

τ′=(\sqrt{2})⁻¹ (10)

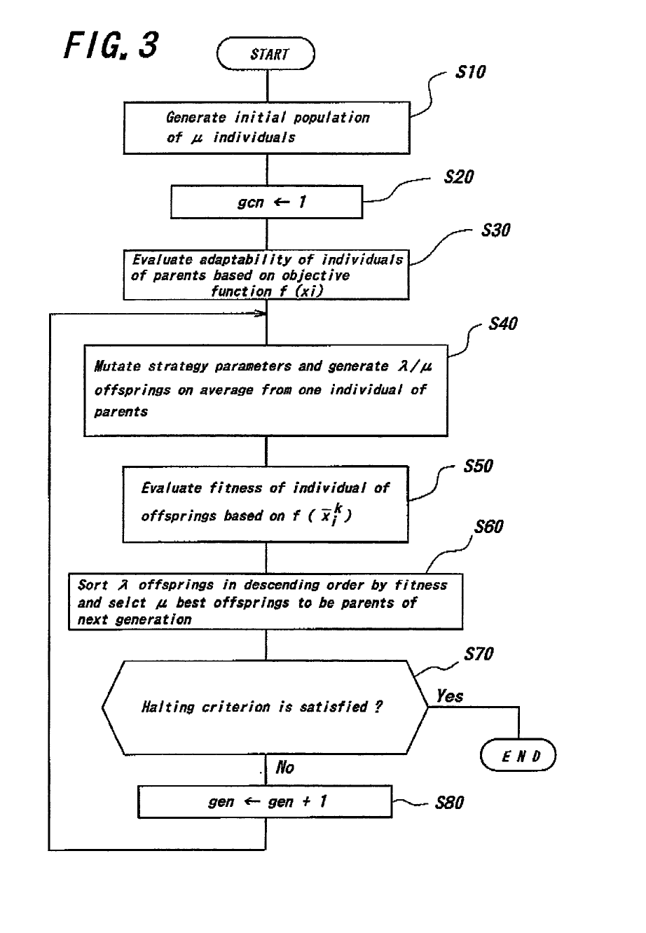

FIG. 3 is a flow diagram showing an algorithm of the conventional method of FES. As shown in FIG. 3, the conventional FES has following steps.

At step S10, an initial population including m individuals is randomly generated. At step S20, generation is set to initial state (Gen=1). At step S30, adaptability of individual of parents (i.e. rating scale for measuring relative merit of each individuals) is evaluated based on an objective function f(Xᵢ). At step S40, strategy parameters of each individual are mutated to generate offsprings, so that λ/μ offsprings on average are created from one individual of parents. That is total of λ offsprings are generated from μ parents. At step S50, fitness of individual of offsprings is calculated based on an objective function ƒ(\tilde{χ}ᵢ^{k}). At step S60, λ offsprings are sorted in descending order by their evaluated fitness value to select μ best offsprings to be parents of next generation from λ. In this manner, natural selection is done. At step S70, it is determined whether or not the fitness of the each individuals is larger than a threshold (i.e. halting criterion). If yes, the process is terminated, otherwise, the process goes to next step S80. At step S80, the generation number is incremented by 1 (gen=gen+1), and then the process return to step S40.

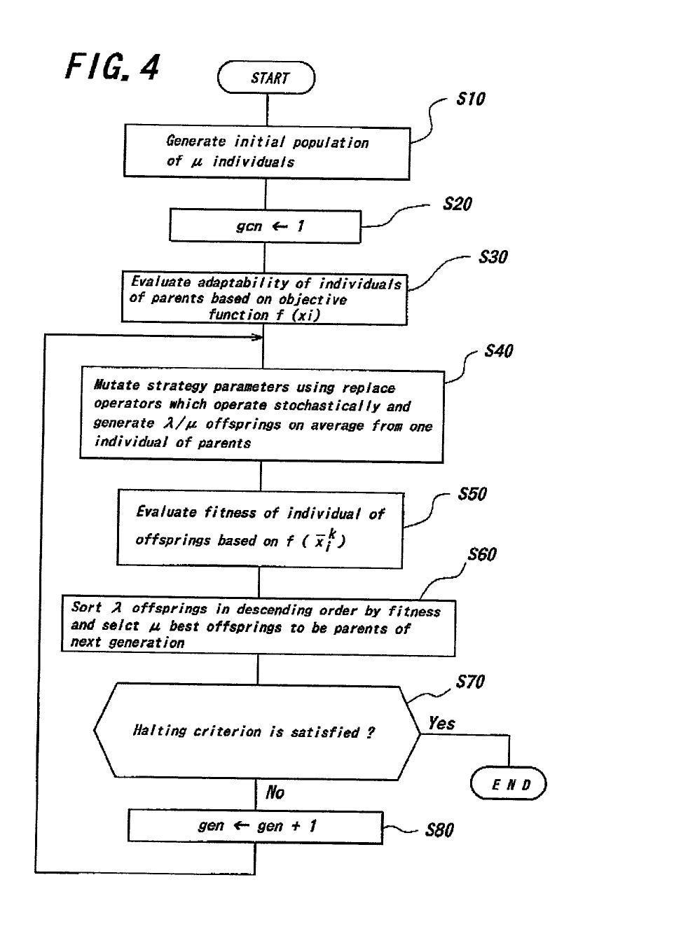

FIG. 4 is a flowchart illustrating an algorithm of the method of RES (Robust Evolution Strategies, that is the evolution strategy computing method having redundant strategy parameters) according to the present invention. As shown in FIG. 4, the RES has following steps.

At step S10, An initial population including m individuals is randomly generated. At step S20, generation is set to initial state (Gen=1). At step S30, adaptability of individual of parents (i.e. rating scale for measuring relative merit of each individuals) is evaluated based on an objective function f(Xᵢ).

At step S42, replace parameters, which operate stochastically in mutation, are used to mutate strategy parameters of each individual to generate offsprings, so that λ/μ offsprings on average are created from one individual of parents. That is total of λ offsprings are generated from μ parents. At step S50, fitness of individual of offsprings is calculated based on an objective function

$$f ( {\tilde{x}}_{i}^{k} ) .$$

At step S60, λ offsprings are sorted in descending order by their evaluated fitness value to select μ best offsprings to be parents of next generation from λ, thus natural selection is done. At step S70, it is determined whether or not the fitness of the each individuals is larger than a threshold (i.e. halting criterion). If yes, the process is terminated, otherwise, the process goes to next step S80. At step S80, the generation number is incremented by 1 (gen=gen+1), then the process return to step S40.

It can be understood from FIG. 3 and FIG. 4 that RES of the invention is different in step S42 than in step S40 of the conventional FES. All other steps in RES of the embodiment of the invention are the same as FES.

The algorithm of RES according to the invention will be described in further detail. Firstly, individual representation Xᵢ is defined as follows:

Xᵢ={χᵢ(j),ηᵢ(j,p)} (11)

where j=1, . . . ,n, p=1, . . . ,m. It is noted that each χᵢ(j) has m strategy parameters, on one hand, the traditional ES has only one strategy parameter. Then offsprings

$${\tilde{X}}_{i}^{k} ( j ) = \{ {\tilde{x}}_{i}^{k} ( j ) , {\tilde{η}}_{i}^{k} ( j , p ) \}$$

are generated in the same manner as FES in the following way (refer to the S70):

$${\tilde{x}}_{i}^{k} ( j ) = {x}_{i} ( j ) + {\tilde{η}}_{i}^{k} ( j , 1 ) {σ}_{k i}^{j} \qquad ( 12 )$$

where σₖᵢ^{j} is a random number calculated for each of i, j and k based on Cauthy distribution type of mutation. Any distribution type other than the Cauthy may be used in mutation, but it is preferred to use the Cauthy distribution in mutation. Although individual Xᵢ has m×n strategy parameters, only fist element \tilde{η}ᵢ^{k}(j,1) is used when generating an offspring. Thus, we now call \tilde{η}ᵢ^{k}(j,1) active strategy parameter and \tilde{η}ᵢ^{k}(j,p) (where p=2, . . . ,m) inactive parameters.

Three types of replace parameters, which operate stochastically in mutation, are used to mutate strategy parameters of respective individuals to generate offsprings, so that λ/μ offsprings are created from one individual of parents on average. That is total offsprings are generated from parents. Since the replace parameters operate stochastically, it may happen in some cases that none of the replace parameters operates, or all of the three replace parameters operate all together. Therefore, it is determined based on predetermined probability of each of replace parameters that which replace parameter (or parameters) operates. The arrays of strategy parameters are operated (i.e. rearranged and/or replaced) based on the replace operator (or operators), which is determined to operate, In this manner, mutate is effected. In this embodiment, three replace parameters are used, but according to the invention, other kinds of replace parameters or more replace parameters may be used, if necessary.

$$\begin{matrix}\begin{matrix}{O}_{dup} : {η}_{i}^{′} ( j , 1 ) = {η}_{i} ( j , 1 ) \\ {η}_{i}^{′} ( j , p ) = {η}_{i} ( j , p - 1 ) , ∀ p ∈ \{ 2 , … , m \} \\ {\tilde{η}}_{i}^{k} ( j , p ) = D ( {η}_{i}^{′} ( j , p ) ) , ∀ p ∈ \{ 1 , … , m \}\end{matrix} & ( 13 ) \\ \begin{matrix}{O}_{del} : {η}_{i}^{′} ( j , p ) = {η}_{i} ( j , p + 1 ) , ∀ p ∈ \{ 1 , … , m - 1 \} \\ {η}_{i}^{′} ( j , p ) = min ( {η}_{max} , {\sum }_{p = 1}^{m - 1} \tilde{η} ( j , p ) ) \\ {\tilde{η}}_{i}^{k} ( j , p ) = D ( {η}_{i}^{′} ( j , p ) ) , ∀ p ∈ \{ 1 , … , m \}\end{matrix} & ( 14 ) \\ \begin{matrix}{O}_{inv} : {η}_{i}^{′} ( j , p ) , ∃ p ∈ f \{ 2 , … , d \} \\ {η}_{i}^{′} ( j , p ) = {η}_{i} ( j , 1 ) \\ {\tilde{η}}_{i}^{k} ( j , p ) = D ( {η}_{i}^{′} ( j , p ) ) , ∀ p ∈ \{ 1 , … , m )\end{matrix} & ( 15 )\end{matrix}$$

where D is a mutation same as equation (7), and ηₘₐₓ is a constant.

O_{dup} shifts all of ηᵢ(j,p) into adjacent position of (p+1) and removes ηᵢ(j,m), which is most right one, from the list.

Then, mutation is done with D.

O_{del} discards ηᵢ(j,1) and moves ηᵢ(j,p) except the discarded one to the adjacent position (p−1) and place the smaller value either ηₘₐₓ or

$${\sum }_{p = 1}^{m - 1} {η}_{i} ( j , p )$$

into ηᵢ(j,m) (i.e. at the m-th position ). Then, it modifies them with D.

Oᵢₙᵥ swaps the active strategy parameter ηᵢ(j,1) with one of the inactive strategy parameters ηᵢ(j,p) (where p=2, . . . ,m). Then it modifies them with D.

It is noted that the RES of the invention has the same computational steps as those of CES or FES in most respects. The enhanced potion in the RES of the invention is that offsprings are generated by equation (12) after applying stochastically above described O_{dup}, O_{del} and Oᵢₙᵥ in stead of mutating all of the parameters with equation (7).

Consequently, through the three types of mutation, RES utilizes an neutral region for memorizing the strategy values that have been effective enough to survive, generating similar but different strategies by accumulating neutral changes on them, activating the modified strategies stochastically. Thus, the active strategy parameters are not fixed on tiny small values by natural selection, but capable of becoming larger or smaller very quickly by only one action of O_{del} or Oᵢₙᵥ. FES is substantially equivalent to RES of the invention if application probabilities of O_{dup}, O_{del} and Oᵢₙᵥ are set to 1, 0 and 0, respectively.

In order to make clear the effectiveness of the RES of the invention and its characteristic in evolutionary process, we studied the effect of RES on typical two test functions (hypershpere function(f₁), Ackley function(f₂)) with comparing to effects of typical conventional method CES and FES.

These two functions on testing are defined in a 30 dimensional search space, where global minimum f_{i,min}=0 is found at origin point (0, . . . ,0). According to the experiments of Yao and Liu, (m, 1)=(30, 200) with mutation, no correlated mutations or recombination is adopted for all computer simulations, in order to compare the result in it. The upper bound of strategy parameters ηₘₐₓ is set to 3.0. The lower bound of them ε is set to 10⁻², 10⁻⁴, 10⁻⁶, 10⁻⁸, 10⁻¹⁰ and 0.0 (10^{-∞}) in each simulations. Then, results are averaged over 50 runs for each conditions. In the RES, the application probabilities of O_{dup}, O_{del} and Oᵢₙᵥ are set to 0.6, 0.3 and 0.1, respectively. In this test, FES is simulated in the RES program with following conditions in order to attain a substantial equivalence to FES: the application probabilities of O_{dup}, O_{del} and Oᵢₙᵥ are set to 1.0, 0 and 0, respectively.

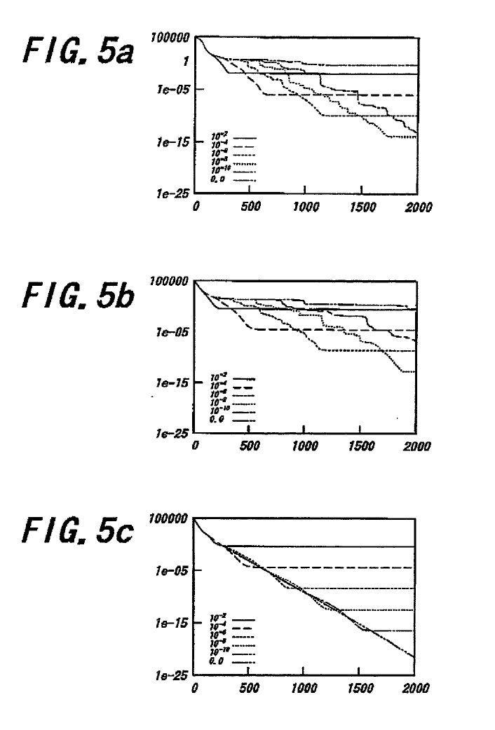

FIGS. 5a, 5b and 5c are graphs illustrating the results of simulation with respect to the hypersphere function f₁ in CES, FES and RES according to the invention, respectively, with six different lower bound conditions. In the graphs, the vertical axis denotes the value of objective function, and the horizontal axis represents the generation number, As shown in FIGS. 5a, 5b and 5c, the solid line curves represent the results of 10⁻² in each simulations, other dotted and broken line curves denote the results of 10⁻⁴, 10⁻⁶, 10⁻⁸, 10⁻¹⁰ and 0.0 (10^{-∞}), respectively. It is apparent from these graphs that in the conventional CES and FES, as the lower bound of the strategy parameters gets smaller, the convergence speed to optimal solution becomes lower. Although the function f₁ is a single-peak function and its landscape is simple, since the dimension is so high, the CES and FES techniques could not find appropriately search direction, so that the techniques demonstrate a tendency to remain on that point due to the observed phenomenon. At the same time, in RES according to the invention, there is no phenomenon described above on the lines of CES or FES, and the search speed remains nearly unaffected by the value of lower bound to converge final stable condition as its lower bound.

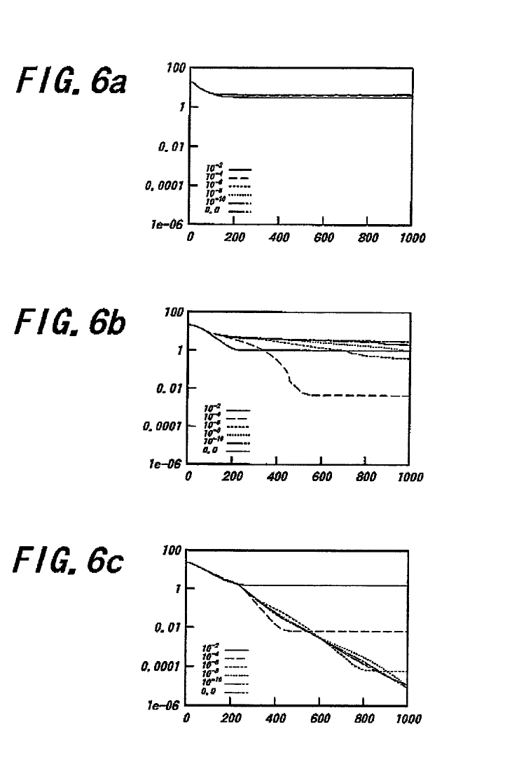

FIGS. 6a, 6b and 6c are graphs depicting the results of simulation with respect to the Ackley function f₂ in CES, FES and RES according to the invention, respectively, with six different lower bound conditions. Since the function f₂ is a multiple-peak function and its landscape is so complicated and has many local optimum, the CES and FES techniques could not find appropriately search direction to converge one of the local optimum. As shown in FIG. 6c, in RES according to the invention, such phenomenon could not be found and the RES could successfully find optimal solution, as well as f₁.

Industrial Applicability

As mentioned above, the evolution strategy computing system and method having redundant strategy parameters significantly improve a robustness of searching and a searching performance by preventing that the strategy parameters approach to zero in early stage. The method and system of the invention are widely usable to various kinds of engineering real function optimization problems. Thus, the method and system of the invention are applicable to design of the control system of an autonomous mobile robot as matter of course, and are widely applicable to design things, which can be treated as real function optimization problem, such as normal engineering design, image recognition design and circuit design.

What is claimed is:

1. An evolution strategy computing system handling individuals consisting of real values, comprising:
storage means for storing a matrix of strategy parameters comprising an active strategy parameters and a plurality of inactive strategy parameters and at least one replace operator having a predetermined probability;
operating means for reading the replace operator from said storage means to operate the matrix of the strategy parameters of respective individuals based on the probabilities of the readout replace operators;
strategy parameter mutation means for mutating said operated strategy parameters in the matrix; and
individual mutation means for mutating said individuals consisting of real values based on said operated and mutated strategy parameters in the matrix.

2. The system according to claim 1, wherein said mutation means mutates in Cauthy type.

3. The system according to claim 1, wherein said matrix of the strategy parameters consists of an active strategy parameter η(j, 1) and inactive strategy parameters η(j, 2)−η(j, m), and said operating means comprises first shifting means for shifting all of said strategy parameters except a leftmost parameter to one's immediate right position one by one in the matrix and for removing the leftmost parameter.

4. The system according to claim 1, wherein said matrix of the strategy parameters consists of an active strategy parameter η(j, 1) and inactive strategy parameters η(j, 2)−η(j, m), and said operating means comprises second shifting means for shifting all of each of said inactive parameters to one's immediate left position one by one in the matrix to replace the active strategy parameter with the inactive strategy parameter in one's immediate right position.

5. The system according to claim 1, wherein said matrix of the strategy parameters consists of an active strategy parameter η(j, 1) and inactive strategy parameters η(j, 2)−η(j, m), and said operating means comprises swap means for swapping said active strategy parameter for one of said inactive parameters which is randomly selected.

6. An evolution strategy computing method handling individuals consisting of real values comprising the steps of:
storing an matrix of strategy parameters comprising an active strategy parameter and inactive strategy parameters, and at least one replace operator having predetermined probability in storage means;
reading the replace operator from said storage means to operate the matrix of the strategy parameters of respective individuals based on the probability of the readout replace operator;
mutating said operated strategy parameters in the matrix; and
mutating said individuals consisting of real values based on said operated and mutated strategy parameters in the matrix.

7. The method according to claim 6, wherein said mutating step mutates in Cauthy type.

8. The method according to claim 6, wherein said matrix of the strategy parameters consists of an active strategy parameter η(j, 1) and inactive strategy parameters η(j, 2)−η(j, m), and said operating step comprises a first shifting step for shifting all of said strategy parameters except a leftmost parameter to one's immediate right position one by one in the matrix and for removing the leftmost parameter.

9. The method according to claim 6, wherein said matrix of the strategy parameters consists of an active strategy parameter η(j, 1) and inactive strategy parameters η(j, 2)−η(j, m), and said operating step comprises a second shifting step for shifting all of said inactive parameters to one's immediate left position one by one in the matrix to replace the active strategy parameter by the inactive strategy parameter in one's immediate right position.

10. The system according to claim 6, wherein said matrix of the strategy parameters consists of an active strategy parameter η(j, 1) and inactive strategy parameters η(j, 2)−η(j, m), and said operating step comprises a swap step for swapping said active strategy parameter for one of said inactive parameters which is randomly selected.

11. A program for executing an evolution strategy computing method handling individuals consisting of real values, said program comprising the steps of:
storing an matrix of strategy parameters comprising an active strategy parameter and inactive strategy parameters and at least one replace operator having predetermined probability in storage means;
reading the replace operator from said storage means to operate the matrix of the strategy parameters of each of the individuals based on the probability of each of the readout replace operators;
mutating said operated strategy parameters in the matrix; and
mutating said individuals consisting of real values based on said operated and mutated strategy parameters in the matrix.

12. The program according to claim 11, wherein said mutating step mutates in Cauthy type.

13. The program according to claim 11, wherein said matrix of the strategy parameters consists of an active strategy parameter η(j, 1) and inactive strategy parameters η(j, 2)−η(j, m), and said operating step comprises a first shifting step for shifting all of said strategy parameters except a leftmost parameter to one's immediate right position one by one in the matrix and for removing the leftmost parameter.

14. The program according to claim 11, wherein said matrix of the strategy parameters consists of an active strategy parameter η(j, 1) and inactive strategy parameters η(j, 2)−η(j, m), and said operating step comprises a second shifting step for shifting all of said inactive parameters to one's immediate left position one by one in the matrix to replace the active strategy parameter with the inactive strategy parameter in one's immediate right position.

15. The program according to claim 11, wherein said matrix of the strategy parameters consists of an active strategy parameter η(j, 1) and inactive strategy parameters η(j, 2)−η(j, m), and said operating step comprises a swapping step for swapping said active strategy parameter for one of said inactive parameters which is randomly selected.
